(19) United States
(12) Patent Application Publication
(10) Pub. No.: US 2015/0368947 A1
(43) Pub. Date: Dec. 24, 2015

(54) REVERSIBLE DOOR

(71) Applicant: SAMSUNG ELECTRONICS CO., LTD., Suwon-si (KR)

(72) Inventors: Chang Bae YEOM, Yongin-si (KR); Ji Hoon SEONG, Suwon-si (KR); Nu Ri SHIN, Seongnam-si (KR)

(21) Appl. No.: 14/840,684

(22) Filed: Aug. 31, 2015

Related U.S. Application Data
(62) Division of application No. 13/626,171, filed on Sep. 25, 2012, now Pat. No. 9,145,636.

(30) Foreign Application Priority Data
Sep. 26, 2011 (KR) 10-2011-0096768

(51) Int. Cl. E05D 7/02; D06F 39/14; D06F 58/20; E05D 15/50

(52) U.S. Cl. CPC E05D 7/02; E05D 15/50; D06F 39/14; D06F 58/20

(57) ABSTRACT

A laundry handling apparatus having a body provided with an inlet, a door to open/close the inlet, and a hinge assembly for the door to be rotatably installed to the body. The door is provided at both sides of a rear surface thereof with a hinge installation part at which the hinge assembly is installed, and the hinge assembly is installed at one of the two hinge installation parts, thereby enabling the change of an opening/closing direction of the door in a convenient manner.

### CROSS-REFERENCE TO RELATED APPLICATIONS

This application is a divisional of U.S. application Ser. No. 13/626,171 filed on Sep. 25, 2012, which claims the benefit of Korean Patent Application No. 10-2011-0096768, filed on Sep. 26, 2011 in the Korean Intellectual Property Office, the disclosures of which are incorporated herein by reference.

### BACKGROUND

1. Field

Embodiments of the present disclosure relate to a laundry handling apparatus having a door configured to open/close an inlet provided at a front surface of a body thereof.

2. Description of the Related Art

In general, a laundry handling apparatus includes a washing machine configured to wash a laundry and a drying apparatus configured to dry a laundry that is washed.

A laundry handling apparatus includes a body provided with an inlet at a front surface thereof to input a laundry into the inside thereof and a door rotatably installed at one side of a front surface of the body to open/close the inlet.

In general, a door having a circular shape applied to the laundry handling apparatus is widely used. Recently, a laundry handling apparatus that is provided with a rectangular shaped inlet at a body thereof and including a rectangular shape door to open/close the rectangular shape inlet, so that a laundry at an inside thereof may be easily taken out, has also been developed.

A rectangular shaped door may be provided with an upper portion and a lower portion in an asymmetrical manner according to a design thereof, and the rectangular shaped door as such may not be installed at a body in a state where the opening/close direction can be changed, and thus a rectangular door needs to be manufactured according to an opening/closing direction.

### SUMMARY

Therefore, it is an aspect of the present disclosure to provide a laundry handling apparatus having an opening/closing direction of a door changeable.

It is another aspect of the present disclosure to provide a laundry handling apparatus having a door easily installed thereto.

Additional aspects of the disclosure will be set forth in part in the description which follows and, in part, will be apparent from the description, or may be learned by practice of the disclosure.

In accordance with one aspect of the present disclosure, a laundry handling apparatus includes a body, a door and a hinge assembly. The body may be provided with an inlet thereto to input a laundry. The door may have one end thereof hinged to the body to open/close the inlet and having two hinge installation parts each provided at both sides of a rear surface thereof in a concave manner. The hinge assembly may be installed at one of the two hinge installation parts so that the door is rotatably installed to the body.

The hinge assembly may include a hinge member installed at the body, and a hinge bracket installed at one of the two hinge installation parts and provided with the hinge member rotatably coupled thereto.

The hinge member may include a fixation part fixed to the body, a hinge part having a circular cross section and rotatably installed at the hinge bracket, and a connecting part configured to connect the fixation part to the hinge part. The hinge bracket may include a first hinge bracket and a second hinge bracket that have the hinge part rotatably installed thereinbetween.

The second hinge bracket may include a hinge groove at which the hinge part is rotatably installed, and the second hinge bracket may include a hinge supporting part for the hinge part to maintain a state of being installed at an inside the hinge groove.

The laundry handling apparatus may further include an installation part cover to cover the other one of the two hinge installation parts.

The installation part cover may include a latch for an inlet to maintain a closed state by a door.

The door may have an upper portion and a lower portion that are asymmetrical to each other.

The door may be formed in a rectangular shape.

The laundry handling apparatus may further include a fixation bracket disposed at a rear surface of a front panel forming a front surface of the body for an installation of the hinge member. The hinge member may include a supporting part protruding from a rear surface of the fixation part and penetrating the front panel so as to be supported by the fixation bracket, and at least one first fastening hole to fix the hinge member to the front surface of the body. The fixation bracket may include a second fastening hole provided at a position corresponding to the first fastening hole and a supporting hole into which the supporting part is inserted and supported thereto.

The supporting part may be provided with both side surfaces formed in parallel to each other in a shape of flat plane, and the supporting hole may be provided with both side ends formed in parallel to each other in a linear shape to correspond to the supporting part.

The fastening hole may be formed at least one of an upper side and a lower side of the supporting part.

In accordance with another aspect of the present disclosure, a laundry handling apparatus includes a body, a door, a hinge member and a fixation bracket. The body may be provided with an inlet to input a laundry thereto. The door may have one end thereof hinged to the body to open/close the inlet. The hinge member may be configured to enable the door to be rotatably installed at the body. The fixation bracket may be disposed at a rear surface of a front surface panel forming a front surface of the body for an installation of a hinge assembly. The hinge member may include a supporting part protruding from a rear surface of a fixation part, which is fixed to the body, and penetrating the front panel so as to be supported by the fixation bracket, and at least one first fastening hole to fix the hinge member to the front surface of the body. The fixation bracket may include a second fastening hole provided at a position corresponding to the first fastening hole, and a supporting hole into which the supporting part is inserted and supported thereto.

As described above, by reversing the installation positions of the hinge assembly and the installation part cover installed at the door, the opening/closing direction of the door may be simply changed.

In addition, as described above, since the hinge member is supported at the supporting hole of the fixing bracket through the supporting part, if a screw is fastened to one of the first fastening holes and one of the second fastening holes both of which correspond to each other, the remaining one of the first fastening holes and the remaining one of the second fastening holes are positioned to correspond to each other, so that the screw may be easily fastened to the remaining one of the first fastening holes and the remaining one of the second fastening holes.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view illustrating a laundry handling apparatus according to an embodiment of the present disclosure.

FIG. 2 is an exploded perspective view illustrating a door and a hinge assembly applied to the laundry handling apparatus according to the embodiment of the present disclosure.

FIGS. 3 to 4 are perspective views illustrating a hinge assembly and an installation cover part installed at the door applied to the laundry handling apparatus according to the embodiment of the present disclosure.

FIGS. 5 to 6 are exploded perspective views illustrating a hinge member being installed at a front surface panel of a body of the laundry handling apparatus according to the embodiment of the present disclosure.

### DETAILED DESCRIPTION

Reference will now be made in detail to the embodiments of the present disclosure, examples of which are illustrated in the accompanying drawings, wherein like reference numerals refer to like elements throughout.

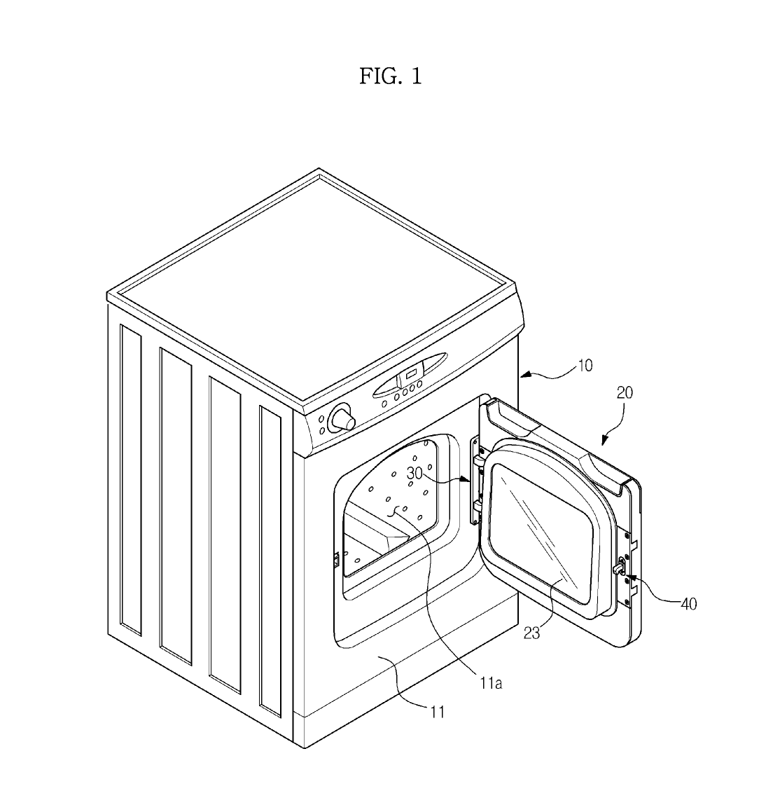

Referring to FIG. 1, a laundry handling apparatus according to an embodiment of the present disclosure includes a body 10 forming an exterior and provided with an inlet 11a at a front surface thereof to input a laundry, a door 20 having one end thereof rotatably installed at the body 10 while rotating in left and right directions to open/close the inlet 11a, and a hinge assembly 30 for the door 20 to be rotatably installed at the body 10.

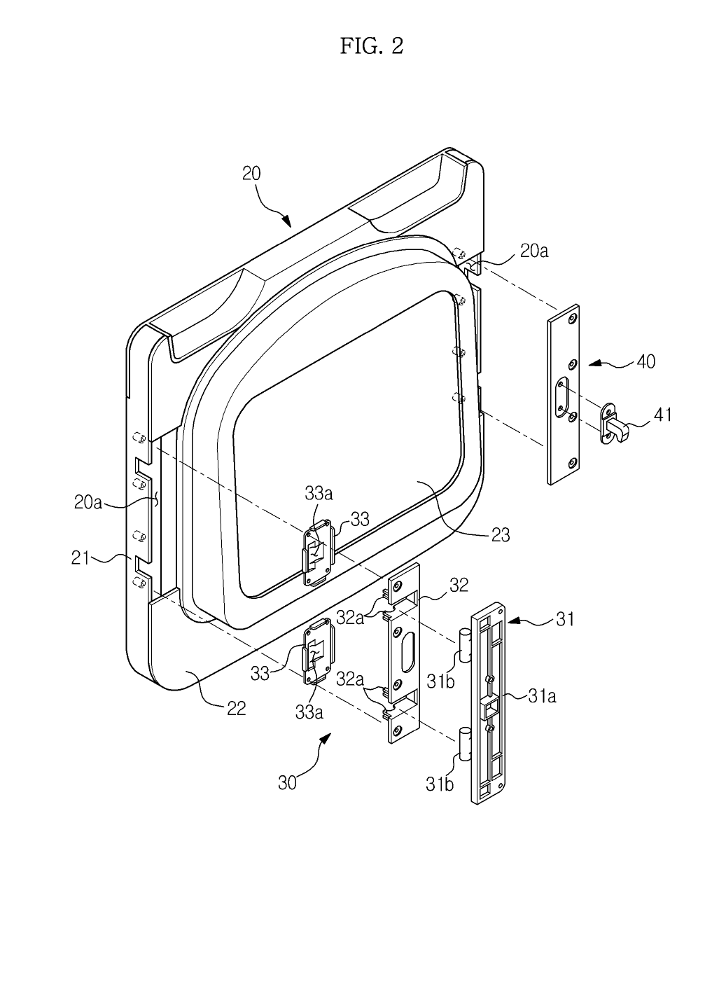

The door 20 according to the embodiment of the present disclosure is formed in a rectangular shape having an upper portion and a lower portion thereof to be asymmetric to each other, and is provided with a transparent window 23 at a center thereof to check a laundry at an inside the door 20. In addition, the door 20, as illustrated on FIG. 2, includes a door front surface frame 21 forming a front surface of the door 20 and a door rear surface frame 22 forming a rear surface of the door 20. The door front surface frame 21 is provided with a hole having a shape corresponding to a hole of the door rear surface frame 22 and the door front surface frame 21 and the door rear surface frame 22 are provided with a transparent member such as a tempered glass fixed therebetween, thereby forming the transparent window 23 which has been described above.

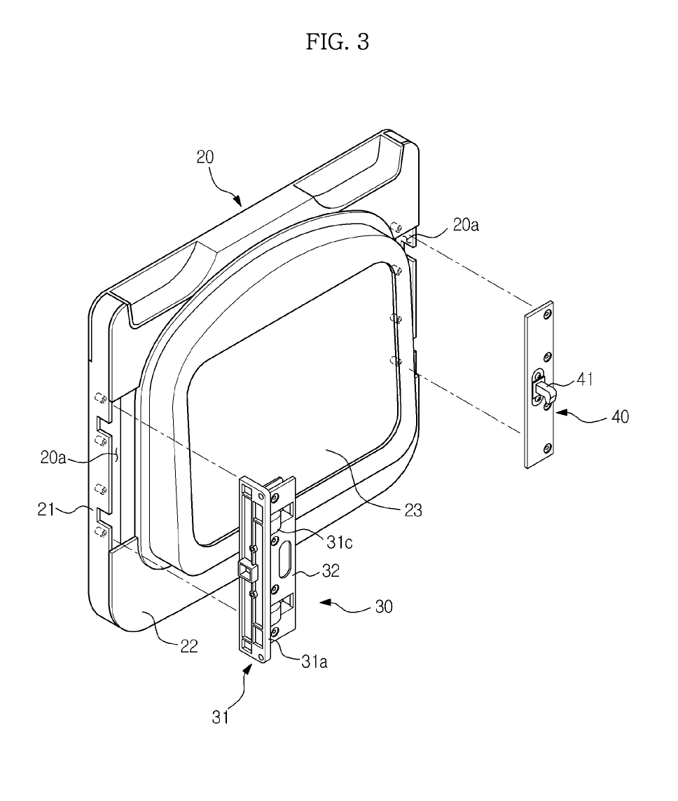

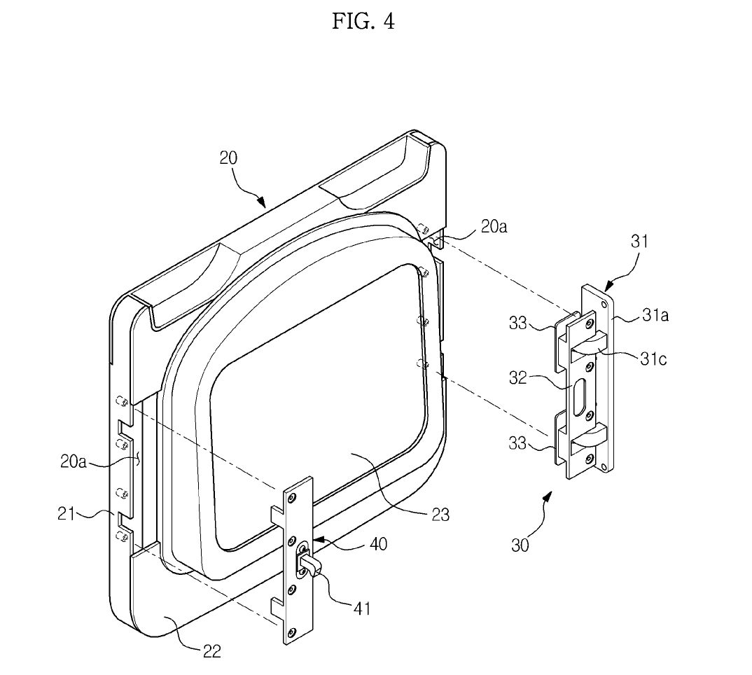

Referring to FIGS. 3 and 4, the door 20 is provided with two hinge installation parts 20a at both sides of a rear surface thereof, respectively, for installation of the hinge assembly 30. The hinge assembly 30 is installed at one of the two hinge installation parts 20a while an installation cover part 40 configured to cover the hinge installation part 20a is installed at the remaining one of the two hinge installation parts 20a. The hinge installation part 20a according to the embodiment of the present disclosure is formed in a shape of a groove by cutting a portion of both sides of the door rear surface frame 22.

Thus, by reversing the hinge installation part 20a, at which the hinge assembly 30 may be installed, and the hinge installation part 20a, at which the installation part cover 40 may be installed, the opening/closing direction of the door 20 may be reversely changed. That is, when viewed from a front side of the body 10, the hinge assembly 30 is installed at the hinge installation part 20a positioned to the right of the laundry handling apparatus and the installation cover 40 is installed at the hinge installation part 20a positioned to the left of the laundry handling apparatus, so that the inlet 11a is open as the door 20 rotates from a left side to a right side thereof. When viewed from a front side of the body 20, the hinge assembly 30 is installed at the hinge installation part 20a positioned to the left of the laundry handling apparatus and the installation cover 40 is installed at the hinge installation part 20a positioned to the right of the laundry handling apparatus, so that the inlet 11a is open as the door 20 rotates from a right side to a left side thereof.

The hinge assembly 30, as illustrated on FIG. 2, includes a hinge member 31 installed at a front surface of the body 10, and hinge brackets 32 and 33 that installed to the door 20 to have the hinge member 31 rotatably coupled thereto so that the door 20 may be rotatably installed at the body 10.

The hinge member 31 includes a fixation part 31a formed in a shape of a panel and fixedly installed to the body 10 through a screw S, a hinge part 31b having a circular cross section and rotatably installed at the hinge brackets 32 and 33, and a connecting part 31c connecting the fixation part 31a to the hinge part 31b. The hinge part 31b according to the embodiment of the present disclosure is provided with two units thereof at an upper portion and a lower portion of the door 20, respectively, to reduce the door 20 being deflected.

The hinge brackets 32 and 33 include a first hinge bracket 32 and a second hinge bracket 33 coupled to each other so that the hinge part 31b may be rotatably installed between the first hinge bracket 32 and the second hinge bracket 33. The second hinge bracket 33 according to the embodiment of the present disclosure includes a hinge groove 33a at which the hinge part 31b is rotatably accommodated. The first hinge bracket 32 is installed to cover the hinge installation part 20a, and includes a hinge supporting part 32a for the hinge part 31b to maintain a state of an installation at the hinge groove 33a. Since two units of hinge parts 31b are provided at the hinge member 31 according to the embodiment of the present disclosure, the second hinge bracket 33 is provided with two units thereof and the two hinge brackets 33 are coupled to an upper portion and a lower portion of the first hinge bracket 32, respectively.

The installation cover 40 includes a latch 41 allowing the door 20 to maintain a closed state of the inlet 11a while interacting with a locking apparatus (not shown) installed at the body 10.

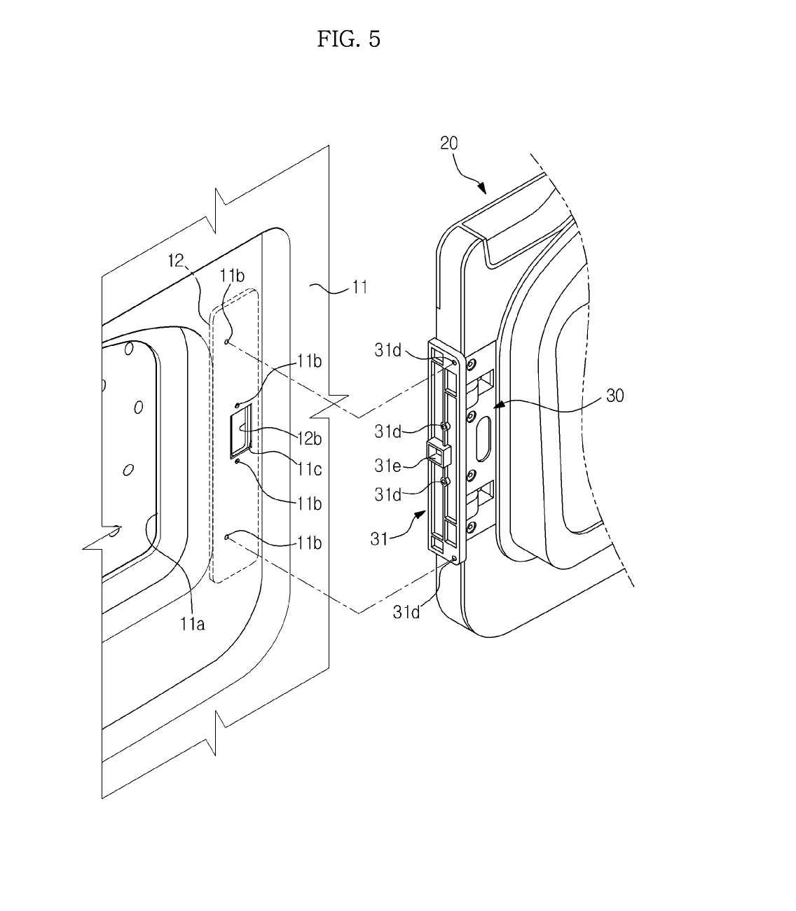

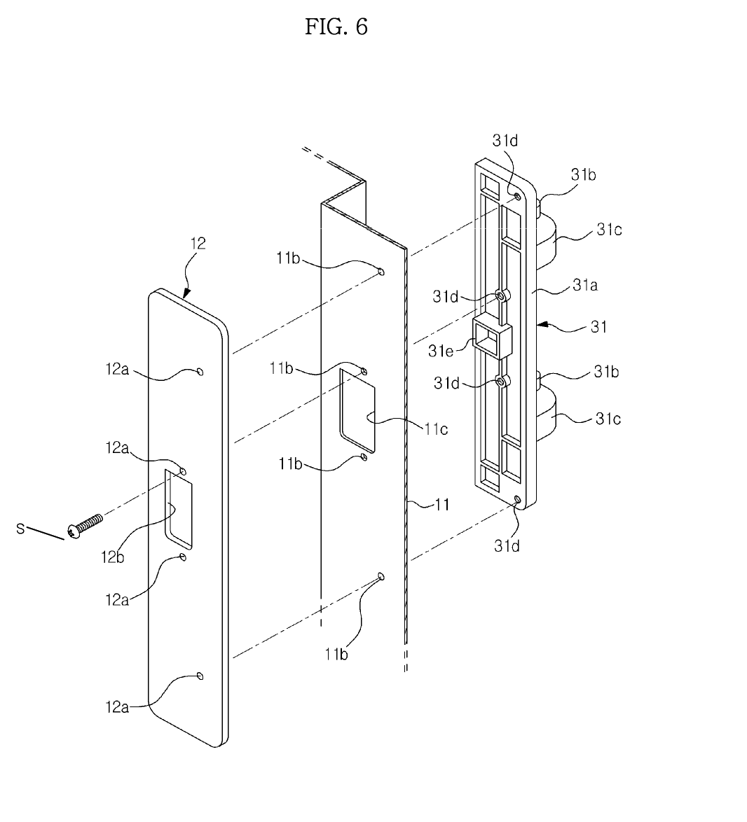

In addition, as illustrated on FIGS. 5 to 6, in order to install the hinge brackets 32 and 33 to the body 10, a fixation bracket 12 is disposed to a rear surface of a front panel 11, which forms a front surface of the body 10, for the hinge member 31 to be fixedly installed at the front surface of the body 10.

The fixation part 31a of the hinge member 31 is provided with a first fastening hole 31d for the hinge member 31 to be fixedly coupled to the fixation bracket 12 through the screw S, and the fixation bracket 12 is provided with a second fastening hole 12a at a position corresponding to the first fastening hole 31d. Accordingly the hinge member 31 may be fixedly installed at the fixation bracket 12 by fastening the screw S at the first fastening hole 31d and the second fastening hole 12a. Each of the first fastening hole 31d and the second fastening hole 12a of the embodiment of the present disclosure is provided in plurality at an upper portion and a lower portion at positions, each first fastening hole 31d corresponding to each second fastening hole 12a so that the hinge member 31 may be prevented from being rotated by the gravity of the door 20. In addition, the front surface panel 11 is provided with a third fastening hole 11b at a position corresponding to the first fastening hole 31d and the second fastening hole 12a so that the screw S may be penetrated and installed to the first fastening hole 31d and the second fastening hole 12a.

When installing the hinge assembly 30 or the hinge member 31 being coupled to the door 20, the hinge member 31 may be rotated by the gravity of the door 20 in a state that the screw S is coupled to one of the first fastening hole 31d and one of the second fastening hole 12a. In this case, in order to fasten the screw S to the remaining one of first fastening holes 31d and the remaining one of the second fastening holes 12a, the door 20 needs to be held in a way to prevent the hinge member 31 from being rotated when the screw S is needed to be fastened to the remaining one of first fastening holes 31d and the remaining one of the second fastening holes 12a.

Thus, the fixation part 31a of the hinge member 31 is provided with a supporting part 31e protruded from a rear surface thereof and supported by the fixation bracket 12, and the fixation bracket 12 is provided with a supporting hole 12b into which the supporting part 31e is inserted and supported. The front surface panel 11 is provided with a penetrating hole 11c thereto so that the supporting part 31e may penetrate through the penetrating hole 11c and be inserted into the supporting hole 12b. The supporting part 31e according to the embodiment of the present disclosure is provided in between the two units of the first fastening holes 31d that are vertically disposed. That is, the first fastening hole 31d is provided each at an upper side and a lower side of the supporting part 31e.

In addition, the supporting part 31e is provided with both side surfaces thereof each formed in a shape of a plane surface that is parallel to each other, and the supporting groove 12b is provided with both side ends thereof each formed in a linear shape that is parallel to each other so that the both side ends may correspond to the supporting part 31e. Thus, as the both side surfaces of the supporting part 31e are either line-contacted or surface-contacted with the both side ends of the supporting hole 12b, the supporting part 31e is supported by the both side ends of the supporting hole 12b in a further stable manner, and thus the rotation of the hinge member 31 is prevented.

With respect to the laundry handling apparatus structured as such, the following is a description of an installation process of a door in a state of an opening/closing direction thereof changed.

First, as illustrated on FIG. 1, in a state when a right end side of the door 20 is installed on a right side of the body through the hinge assembly 30, the hinge assembly 30, that is, the hinge member 31, is separated from the front surface panel 11 of the body 10, so that the door 20 is separated along with the hinge assembly 30. Then, the hinge assembly 30 and the installation part cover 40 are separated from the two units of the hinge installation part 20a provided at the rear surface of the door 20. Sequentially, each of the hinge assembly 30 and the installation part cover 40 is installed at the hinge installation part 20a that is positioned at an opposite side of the position at which the hinge assembly 30 and the installation part cover 40 are originally installed. That is, while having the drawing of FIG. 3 as a reference, the hinge assembly 30 installed at a left side of the rear surface of the door 20 and the installation part cover 40 installed at a right side of the rear surface of the door 20 are installed at opposite positions, as illustrated on FIG. 4.

As described above, in a state of the hinge assembly 30 installed to the door 20 while having the hinge assembly 30 and the installation part cover 40 reversely changed in the position the hinge assembly 30 is fixed again to the front surface panel 11 of the body 10. The fixation of the hinge assembly 30 is taken place by fastening the hinge member 31 to the fixation bracket 12 that is disposed at a rear surface of the front surface panel 11 of the body 10 by use of the screw S.

First, the hinge member 31 is disposed such that the supporting part 31e of the hinge member 31 is installed by passing through the supporting groove 12b, one among the plurality of the first fastening holes 31d and one among the plurality of the second fastening holes 12a both of which correspond to each other are fastened with the screw S. At this time, even in a case when only one screw S is fastened at the first fastening hole 31d and the second fastening hole 12a, the hinge member 31 is in a state of being supported by the both side ends of the supporting hole 12b of the fixation bracket 12 through the both side surfaces of the supporting part 31e, and thus the hinge member 31 maintains a constant position without being rotated. Thus, the remaining one of the first fastening holes 31d and the remaining one of the second fastening holes 12a may maintain a corresponding position to each other, thereby enabling an operator to easily fasten a screw.

The door 20 according to the embodiment of the present disclosure is formed in a rectangular shape while being provided with an upper portion thereof and a lower portion thereof in an asymmetrical manner, but the present disclosure is not limited hereto, and the present disclosure may be applied to various shapes of doors each provided with an upper portion thereof and a lower portion thereof in an asymmetrical manner.

The first fastening hole according to the embodiment of the present disclosure is provided at both an upper side and a lower side of the supporting part, but is not limited thereto, and the first fastening hole may be formed at one side thereof.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A reversible door, comprising:
two symmetrical hinge installation parts each provided at opposing sides of a rear surface of the door, respectively;
a hinge assembly installed at one of the two hinge installation parts, the hinge assembly being configured to be installed at either of the two hinge installation parts; and
an installation part cover installed at an other of the two hinge installation parts, the installation part cover being configured to be installed at either of the two hinge installation parts, and the installation part cover including a latch.

2. The door of claim 1, wherein the hinge assembly comprises:
a hinge member configured to be installed to a body; and
a hinge bracket, the hinge member being rotatably coupled to the hinge bracket.

3. The door of claim 2, wherein the hinge member comprises a fixation part, a hinge part having a circular cross section and rotatably installed at the hinge bracket, and a connecting part configured to connect the fixation part to the hinge part,
the hinge bracket comprises a first hinge bracket and a second hinge bracket that have the hinge part rotatably installed thereinbetween, and
the second hinge bracket comprises a hinge groove at which the hinge part is rotatably installed and a hinge supporting part for the hinge part to maintain a state of being installed at an inside the hinge groove.

4. The door of claim 3, wherein the hinge member further comprises:
a supporting part protruding from a rear surface of the hinge member and configured to penetrate the body; and
at least one first fastening hole to fix the hinge member to the body.

5. The door of claim 1, wherein an upper portion and a lower portion of the door are asymmetrical to each other.
